(19) United States
(12) Patent Application Publication
(10) Pub. No.: US 2014/0254584 A1
(43) Pub. Date: Sep. 11, 2014

(54) NOTIFICATION OF TOO MANY "NO ANSWER" OF FORWARDED TO NUMBER

(71) Applicants: Karthick Rajapandiyan, Kandanchavadi (IN); Muthusamy Muthiah, Kandanchavadi (IN)

(72) Inventors: Karthick Rajapandiyan, Kandanchavadi (IN); Muthusamy Muthiah, Kandanchavadi (IN)

(73) Assignee: ALCATEL LUCENT, Paris (FR)

(21) Appl. No.: 14/128,216

(22) PCT Filed: Sep. 6, 2011
(86) PCT No.: PCT/EP2011/065384

§ 371 Date: May 27, 2014

(30) Foreign Application Priority Data
Jun. 27, 2011 (IN) 2150/CHE/2011

(51) Int. Cl. H04L 29/06

(52) U.S. Cl. CPC H04L 65/1016
USPC 370/352

(57) ABSTRACT

Method and system for notifying subscribers of calls missed by forwarded to number. The present invention relates to services provided by interne protocol multimedia subsystem and more specifically to a system and method of notifying a subscriber about the performance of selected forwarded number. When an call is forwarded to a forward to identity the application server increments a counter in case the call is not answered by the forward to identity. Once this counter reaches a certain threshold, the subscriber is sent a notification of the number of calls missed by selected forward to identity.

### TECHNICAL FIELD

The present invention relates to services provided by an internet protocol multimedia system and more specifically to notifying a subscriber about performance of selected forwarded number in an internet protocol multimedia system.

### BACKGROUND

Internet protocol multimedia subsystem (IMS) architecture allows network operators and service providers to provide multimedia services over both circuit switched networks like PSTN—public switched telephone network and packet switched networks like IP telephony based networks. The IMS architecture allows communication between application servers and end user using open standards that support IP network interfaces and fixed mobile convergence.

The IMS architecture makes use of a Session Initiation Protocol (SIP) for creating session-oriented connections between two or more endpoints in an IP network. The SIP is also responsible for call flow related applications like, call hold, music on hold, unattended transfer, consultation hold, unconditional call forwarding, attended transfer, call forwarding no answer (CFNA), busy call forwarding (BCF), single-line extension, 3-way call, incoming call screening, call pickup, call park, outgoing call screening, automatic redial, click to dial, automatic redial, find-me and so on.

The call forwarding no answer (CFNA) service permits a called subscriber to have the system send incoming calls addressed to the called subscriber's public identity to another public identity (forward-to identity) or to the called subscriber's designated voice mailbox. CFNA does not impact a subscriber's ability to originate calls. A subscriber may select a forward-to identity termination address or telephone when the subscriber registers for CFNA service. CFNA is also called as Call forwarding on No Reply (CFNR). Similarly subscriber may select forward-to indentity i.e forwarded to number for all call forwarding service like Call forwarding on Busy (CFB), Call forwarding unconditional (CFU). The forwarded to identity is expected to handle all the subscriber calls when the subscriber is busy or not answered.

Presently, there are no mechanisms to monitor the performance of a forwarded-to identity and recognize the number of calls missed or not attended by the forwarded-to identity. The performance of the forwarded-to identity is important as missing important calls may lead to loss of a critical information or message. For example, in a business scenario a potential customer may be lost. In another example, not attending to a call may lead to a time critical message being lost.

### SUMMARY

In view of the foregoing, an embodiment herein provides a method for notifying a subscriber of calls not attended by a forward to identity in an internet protocol multimedia subsystem network, comprising of forwarding by the network of a call to a forward to identity received by the subscriber, if the subscriber has call forwarding activated; and informing the subscriber by the network, if the forward to identity not answering the call. The method further comprises incrementing a counter by an application server, on the forward to entity not answering the call, wherein the counter counts number of calls missed by the forward to identity; and comparing the counter to a threshold by the application server. The method comprises of notifying the subscriber of calls not attended by the forwarded to number, if the counter value exceeds or is equal to the threshold. The method comprises of notifying the subscriber by the application server using a call session control function.

Also, disclosed herein is an internet protocol multimedia subsystem network comprising at least one means configured for forwarding of a call to a forward to identity received by the subscriber, if the subscriber has call forwarding activated; and informing the subscriber, if the forward to identity not answering the call. The network further comprises of an application server, wherein the application server further comprises at least one means configured for incrementing a counter, on the forward to entity not answering the call, wherein the counter counts number of calls missed by the forward to identity; and comparing the counter to a threshold. The application server is further configured for notifying the subscriber of calls not attended by the application server, if the counter value exceeds the threshold. The application server further is further configured for notifying the subscriber using the call session control function.

Embodiments herein further disclose an application server in an internet protocol multimedia subsystem network, the application server comprising at least one means configured for forwarding of a call to a forward to identity received by the subscriber, if the subscriber has call forwarding activated; and informing the subscriber, if the forward to identity not answering the call. The application server further comprises at least one means configured for incrementing a counter, on the forward to entity not answering the call, wherein the counter counts number of calls missed by the forward to identity; and comparing the counter to a threshold. The application server is further configured for notifying the subscriber of calls not attended by the forwarded to number, if the counter value exceeds the threshold. The application server is further configured for notifying the subscriber of calls not attended by the forwarded to number, if the counter value is equal to the threshold. The application server further is further configured for notifying the subscriber using the call session control function.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of an IP multimedia subsystem providing services to subscribers, according to the embodiments as disclosed herein;

FIG. 2 is a block diagram of an proxy-call session control function in an IP multimedia subsystem, according to embodiments as disclosed herein;

FIG. 3 is a block diagram of an serving-call session control function in an IP multimedia subsystem, according to embodiments as disclosed herein;

FIG. 4 is a block diagram of an interrogating-call session control function in an IP multimedia subsystem, according to embodiments as disclosed herein;

FIG. 5 is a block diagram of an application server in an IP multimedia subsystem, according to embodiments as disclosed herein;

FIGS. 6A and 6B are flowcharts illustrating the method of a subscriber availing call forwarding service from an IP multimedia subsystem, according to the embodiments as disclosed herein;

FIGS. 7A and 7B are flowcharts illustrating a method of evaluating the performance of a selected call forwarding number in an IP multimedia subsystem, according to the embodiments as disclosed herein and

FIGS. 8A, 8B and 8C are flowcharts illustrating a method of evaluating and notifying the performance of a selected call forwarding number in an IP multimedia subsystem, according to the embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

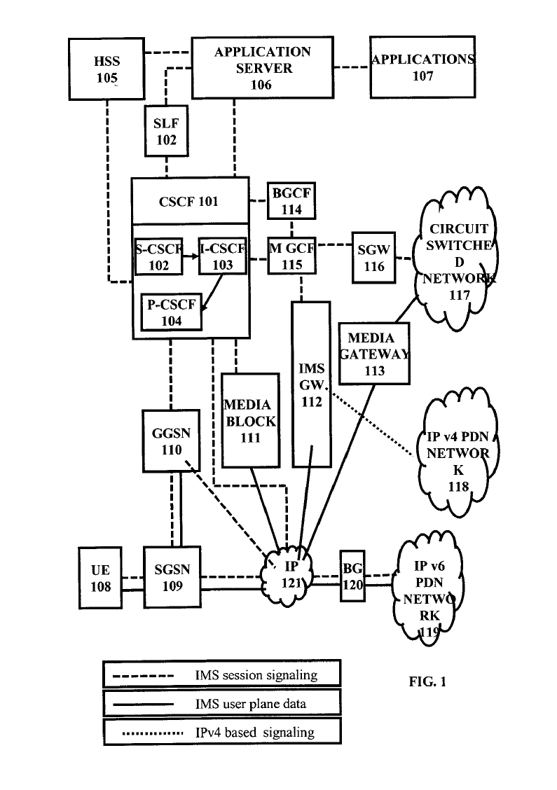

The embodiments herein disclose a system and method of notifying a user the performance of a selected forwarding number. Referring now to the drawings, and more particularly to FIGS. 1 through 4, where similar reference characters denote corresponding features consistently throughout the figures, there are shown embodiments.

FIG. 1 illustrates a block diagram of an IP multimedia subsystem providing services to subscribers, according to the embodiments as disclosed herein. IP Multimedia Subsystem (IMS) is an architecture that enables rich multimedia services across both circuit switched and packet switched networking infrastructures. IMS defines architecture of logical elements using session initiation protocol (SIP) for call signaling between network elements. The main blocks of the IP multimedia subsystem which enable the present invention include the call session control function—CSCF 101, Home subscription server (HSS) 105, and application server (AS) 106.

The Session Initiation Protocol (SIP) is a signaling protocol used by technology products for creating session-oriented connections between two or more endpoints in an IP network. An application server (AS) 106 provides value added services/application 107 and can be located in the home network or any third party network. It is essentially a SIP server which hosts and executes various services.

The Call Session Control Function (CSCF) 101 is the session routing point in the IMS network. It distributes incoming calls to the application services. The CSCF 101 handles initial subscriber authentication. Application services that receive a message from the CSCF 101 are defined to permit the processing of that call, and to perform additional service-related checks. The CSCF 101 uses the SIP message itself to pass the call event to the service and adds additional header information to maintain control of the call. The application server 106 then processes the message independently or returns the message to the CSCF 101. The CSCF 101 then runs the initial subscriber criteria—ISC filters and passes the message on to the next service defined, or ends the data processing. The CSCF comprises of a Proxy-CSCF (P-CSCF) 104, serving-CSCF (S-CSCF) 102 and an interrogating-CSCF (I-CSCF) 103.

The S-CSCF 102 is a SIP (Session Information Protocol) based server and is one of the three types of Call Session Control Functions (CSCF) 101. It is basically a SIP server but performs session control as well. It also maintains a session state as required by the network operator. Within a network there could be a number of S-CSCF's 102 with different functionality and used for different purposes. Some of functions of the S-CSCF include subscriber registration, control session related flow between user equipment 108 and application server 106 and subscription and service charging related monitoring.

The P-CSCF 104 is the first contact between the user and the IMS network 100. All the signaling and control information passes through the P-CSCF 104 before getting to the user. It acts an outbound/inbound SIP proxy server.

The I-CSCF 103 is SIP proxy server; it is placed at the edge of the administrative domain of an IMS network 100. It is a point of contact for a connection destined to the user who belongs to that network, or a roaming user currently located within the service area of that network operator.

The Home Subscriber Server (HSS) 105 provides a central repository for subscriber information. The HSS 105 stores all subscriber information required to establish sessions between users and provide services to subscribers. The HSS stores: subscriber registration, subscriber preferences, subscriber location and services information, such as address books. The HSS stores many types of user information, including a mobile network's Home Location Repository. It provides an interface through which users can gather data. Initial Filter Criteria (iFC) are filter criteria that are stored in the HSS as part of the IMS Subscription Profile and are downloaded to the S-CSCF upon user registration (for registered users) or on processing demand (for services, acting as unregistered users). They represent a provisioned subscription of a user to an application. The iFC are valid throughout the registration lifetime or until the User Profile is changed. The subscriber location function SLF 102 is a very simple database, which maps the user's address with an HSS, where all the user information is stored.

The breakout gateway control function—BGCF 114 provides connectivity to the Circuit Switched domain through a media gateway control function—MGCF 115, SGW Signaling Gateway—SGW 116 and the Media Gateway—MGW 113. These three nodes put together are referred to as the PSTN/CS Gateway. The BGCF 114 is used exclusively for sessions initiated by an IMS user who needs to communicate with a user in PSTN or PLMN (Public Land Mobile Network) domain, both of which are part of circuit switched network 117. The MGCF interfaces with the BGCF 114 and receives the SIP signaling. The MGCF 115 converts the received SIP signal and forwards it to the SGW-116. The SGW 116 provides the signaling interface with the circuit switched domain. Its main function is to perform lower level protocol conversion. The media gateway 113 connects the media plane of the circuit switched network 117 with the media plane of IMS 100 system. The media related blocks 111 handles all the media transportation and processing requirements.

A serving GPRS Support Node (SGSN) 109 is responsible for the delivery of data packets from and to the mobile stations/user equipments 108 within its geographical service area. Its tasks include packet routing and transfer, mobility management (attach/detach and location management), logical link management, and authentication and charging functions. The location register of the SGSN 109 stores location information (e.g., current cell, current VLR) and user profiles (e.g., IMSI, address(es) used in the packet data network) of all GPRS users registered with this SGSN. A Gateway GPRS Support Node (GGSN) 110 is a network node that acts as a gateway between a GPRS wireless data network and the IP multimedia subsystem architecture 100.

The call forwarding no answer (CFNA), Call forwarding on Busy (CFB), Call forwarding unconditional (CFU) services are provided by the IP multimedia subsystem 100 that permits a called subscriber to have the system send incoming calls addressed to the called subscriber's public identity to another public identity (forward-to identity), when the called subscriber fails to answer, or called subscriber is busy with another call or called subscriber has forwarded his call unconditionally. A subscriber may select a forward-to identity termination address or telephone when the subscriber registers the CFNA, CFU, CFB. The forwarded to identity is required to handle all the subscriber calls when the subscriber is busy, does not wish to answer calls, or when forwarded unconditionally. The notification of too many “no answer” from forwarded-to-number may be generally available or may be provided after prearrangement with the service provider or network operator. The subscriber needs to register, subscribe and activate to this new service before trying to use this service. During subscription, a new event like FTNNAN (Forward to Number No Answer Notification) is triggered and subscribed in the application server which is handling the or forwarded-to-number.

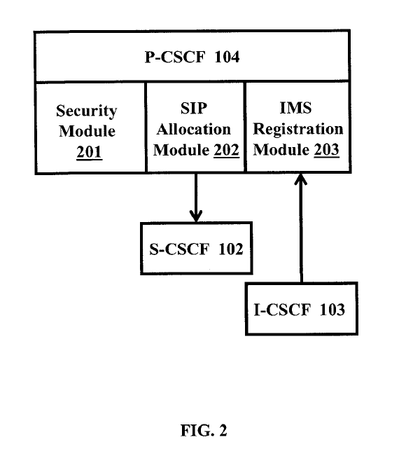

FIG. 2 is a block diagram of a proxy-call session control function in an IP multimedia subsystem, according to embodiments as disclosed herein. The block diagram shown in FIG. 2 contains elements related to the embodiments of the present invention and does not represent P-CSCF 104 entirely. Some of the main elements of the P-CSCF 104 includes the security module 201, the SIP allocation module 202 and the IMS registration module 203. The P-CSCF 104 may be located in the home network or in a visited network. The security module 201 of the P-CSCF 104 authenticates the user and asserts the identity with rest of the nodes in the network. The P-CSCF 104 also allocated the SIP server or the S-CSCF 102 to an user equipment 108. The P-CSCF 104 is also responsible for registering an user equipment 108 with the IP multimedia subsystem. This process called IMS registration 204 of the user equipment 108 is done by allocating the correct S-CSCF 102, using the I-CSCF 103 which provides home domain information of the user equipment 108.

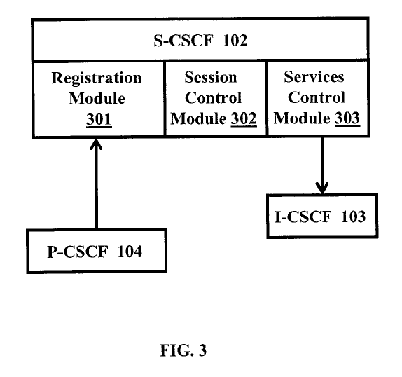

FIG. 3 is a block diagram of a serving-call session control function in an IP multimedia subsystem, according to embodiments as disclosed herein. The block diagram shown in FIG. 3 contains elements related to the embodiments of the present invention and does not represent S-CSCF 102 entirely. The S-CSCF 102 contains a registration module 301, a session control module 302 and a services control module 303. The registration module 301 receives registration related information from the P-CSCF 104. The S-CSCF 104 refers to the HSS 105 of the user 108 and registers them to the system. It is also responsible for checking if a user has subscribed for services. The services control module 303 communicates with the application server 106 using the I-CSCF 103 and receives all service related information regarding a user 108. The S-CSCF 102 is also responsible for maintaining session between user and various parts of the IP multimedia subsystem 100. The session control module 302 is responsible for effective communication between users in case both the user belong to different network providers. Also, the session control module 302 is responsible for controlling sessions between users and services.

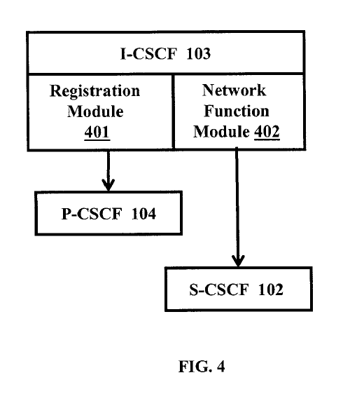

FIG. 4 is a block diagram of an interrogating-call session control function in an IP multimedia subsystem, according to embodiments as disclosed herein. The block diagram shown in FIG. 4 contains elements related to the embodiments of the present invention and does not represent I-CSCF 103 entirely. The I-CSCF 102 contains a registration module 401 and a network function module 402. The I-CSCF 103 communicates with the P-CSCF 104 during the registration of an user equipment 108. The network function module 402 is responsible for finding the next S-CSCF 102 during a hop from one network to another. During the registration process, the I-CSCF 103 assigns a S-CSCF 102 for a particular user.

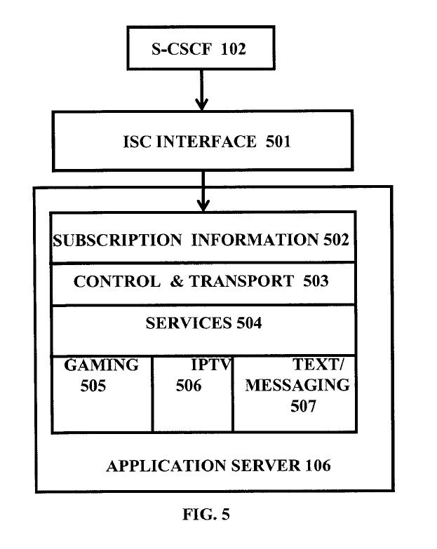

FIG. 5 is a block diagram of an application server (AS) in an IP multimedia subsystem, according to embodiments as disclosed herein. The block diagram shown in FIG. 5 contains elements related to the embodiments of the present invention and does not represent AS 103 entirely. The I-CSCF 102 contains a subscription information module 502, a control and transport information module 503, services block 504. The S-CSCF 102 interfaces with the AS 106 through the ISC interface 501 (IP Multimedia Service Control interface). The subscription information 502 contains all user related information like application downloaded, amount paid for the month, downloading information and so on. The control and transport 503 block is responsible for providing user with services using the IP multimedia subsystem 100. The services block 504 contains a list of service provided by the network provider. The services block 504 shows some of the common applications including gaming 505, IPTV 506 and text/messaging service 507.

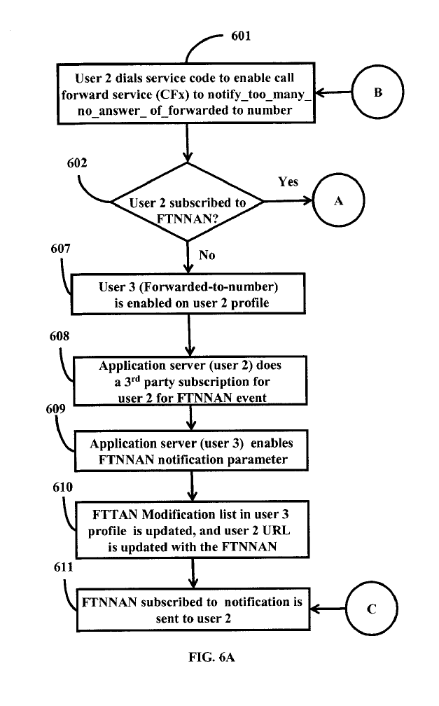

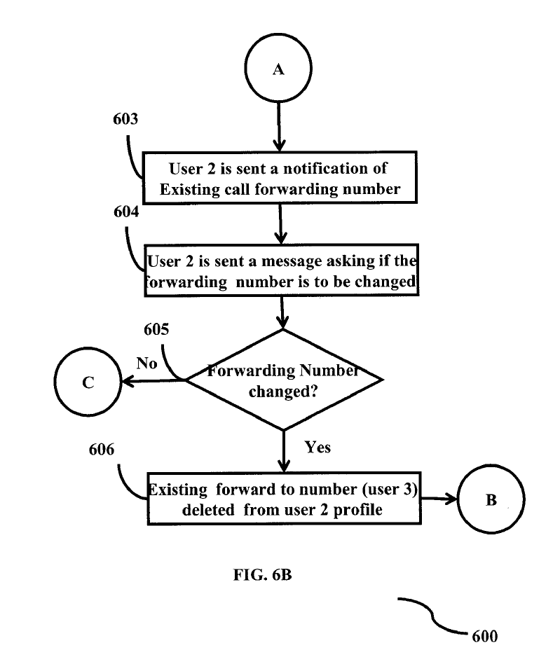

FIGS. 6A and 6B are flowcharts illustrating the method of a subscriber availing call forwarding service from an IP multimedia subsystem, according to the embodiments as disclosed herein. User 2 (served user) dials (601) service code to enable call forward (CFx) service to notify_too_many_no_answer_of_forwarded to number. The service code is to subscribe user 2 to this feature of providing notification of no answer of forward to number. The forward to number may be sent messages in the form of an SIP URI or a TEL URL.

Consider an example,
INVITE SIP: *SC*CFN@post.com, here the CFN is the call forwarding
identity which is user 3@post.com OR
INVITE TEL: *SC* 987022121# where the number 987022121 is identity of user 3 which is the call-forwarded to number.

The AS 106 checks (602) if the call forwarded to number no answer notification (FTNNAN) service is already enabled. If the user 2 is already subscribed to call forwarded to number no answer notification (FTNNAN) service is, User 2 sent (603) a notification of existing call forwarding number (CFN). User 2 is sent (604) a message asking if the forwarding number is to be changed. The AS 106 checks if the user 2 wants the forwarding number to be changed (605). If the forwarding number is changed, the existing forward to number is deleted (606) from user 2 profile and user 2 needs to dial (601) service code to enable call forward (CFx). If the forwarded to number no answer notification (FTNNAN) service is not enabled (602), user 3 (forwarded to number) is enabled (607) on user 2 profile. User 3 gets updated as the call forwarding number/forwarded to identity. The application server 106 of user 2 does (608) a 3^{rd} party subscription for user 2 for FTNNAN (Forwarded To Number No Answer Notification) event. The subscription request may be as follows:

SUBSCRIBE SIP: User 3@post.com;
From: SIP:User 2@post.com;
To: SIP:User 3@post.com

### Event FTNNAN;

On receiving the SUBSCRIBE request application server (user 3) enables (609) FTNNAN new notification parameter and updates (610) the user 2 URL in a FTNNAN modification list of user 3 profile. Finally the terminating application server 106 sends a FTNNAN subscribed notification (611) to user 2. The format of this notification may be as below:

NOTIFY SIP:User2@post.com
Event: FTNNAN
Datatype:application/xml
<data>
<FTNNAN count>0</FTNNAN Status?>
<Comment> Successful Subscription </Comment>
<data>

The various actions in method 600 may be performed in the order presented, in a different order or simultaneously. Further, in some embodiments, some actions listed in FIGS. 6A and 6B may be omitted.

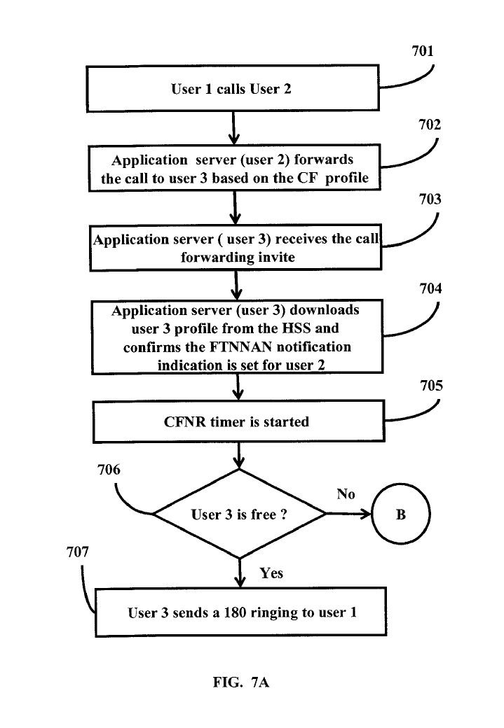

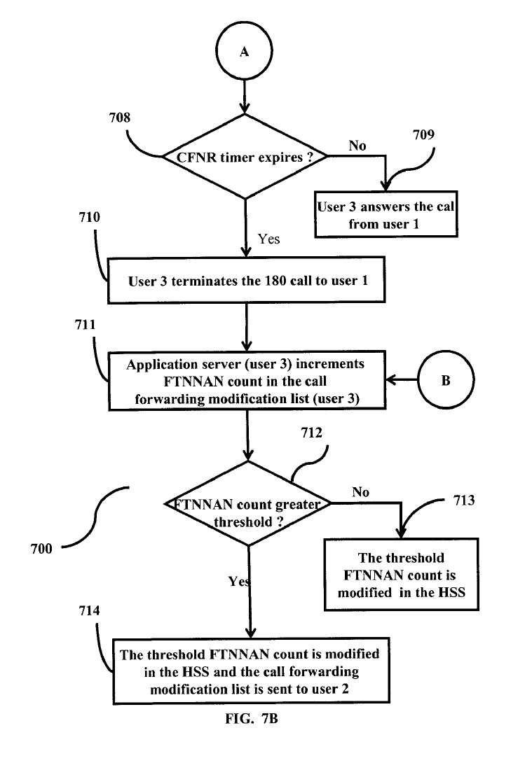

FIGS. 7A and 7B are flowcharts illustrating a method of evaluating the performance of a selected call forwarding number in an IP multimedia subsystem, according to the embodiments as disclosed herein. User 1 calls (702) user 2. User 1 initiate s a call to served user 2 in using the below SIP commands:

INVITE sip:user 2@post.com
From: sip:user 1@post.com
To: sip:user 2@post.com

Application server (user 2) forwards (702) the call to user 3 based on the Call forwarding—CF profile. Application server (user 3) receives (703) the call forwarding invite. Application server (user 3) downloads (704) user 3 profile from the HSS and confirms (704) the CF notification indication is set for user 2. Next, the call forward no response—CFNR timer is started (705). The application server (user 3) checks (706), if the user 3 is free. If the user 3 is not free, then the application server (user 3) increments (711) the FTNNAN count in the call forwarding modification list (user 3). If user 3 is free, a 180 ringing is sent ((707) to the user 1 which initiates the call. IF the CFNR timer does not expire, the user 3 answers (709) the call from user 1. If the CFNR timer expires (708), user 3 terminates (710) the 180 call to user 1. The application server (user 3) terminating the call by sending CANCEL method to user 3 and BYE method to User 1. Application server (user 3) increments (711) FTNNAN count corresponding to user 2, in the call forwarding modification list (user 3). The application server then checks (712) if the FTNNAN count is greater than the threshold. If the count is greater than threshold, the threshold FTNNAN count is modified (714) in the HSS and the call forwarding modification list is sent (714) to user 2. If the count is not greater (712) than threshold, The threshold FTNNAN count is modified (713) in the HSS. The various actions in method 700 may be performed in the order presented, in a different order or simultaneously. Further, in some embodiments, some actions listed in FIGS. 7A and 7B may be omitted.

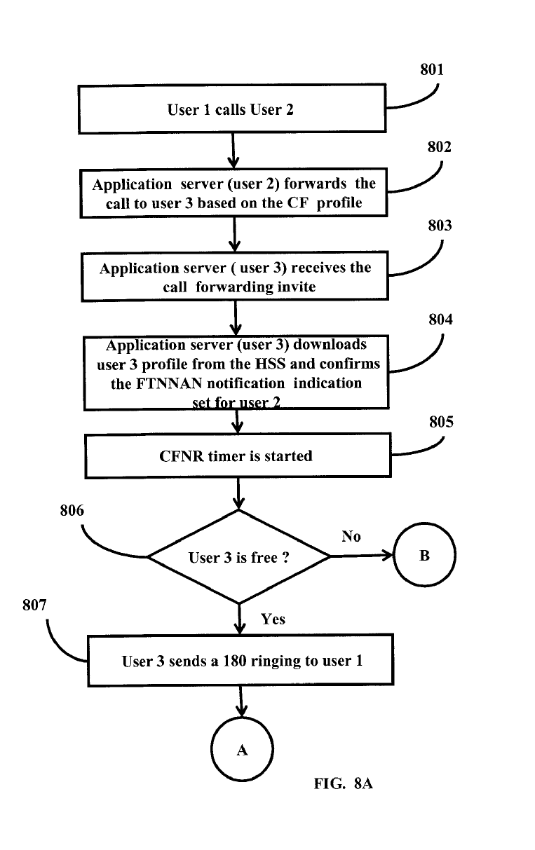

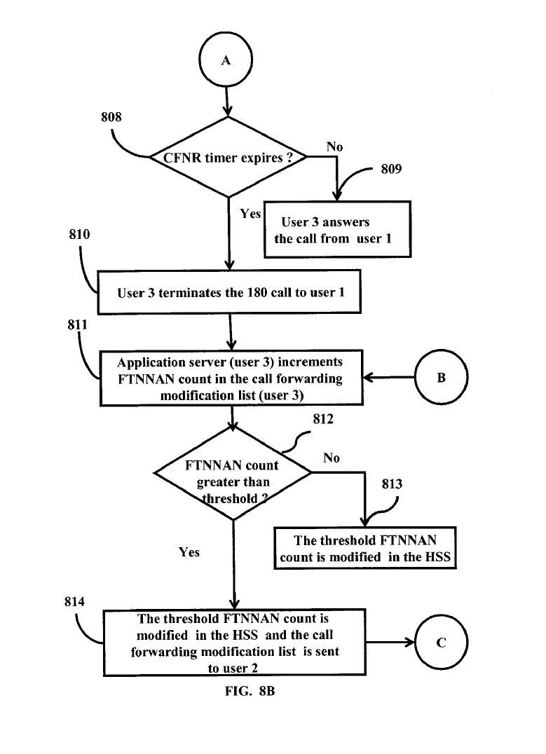

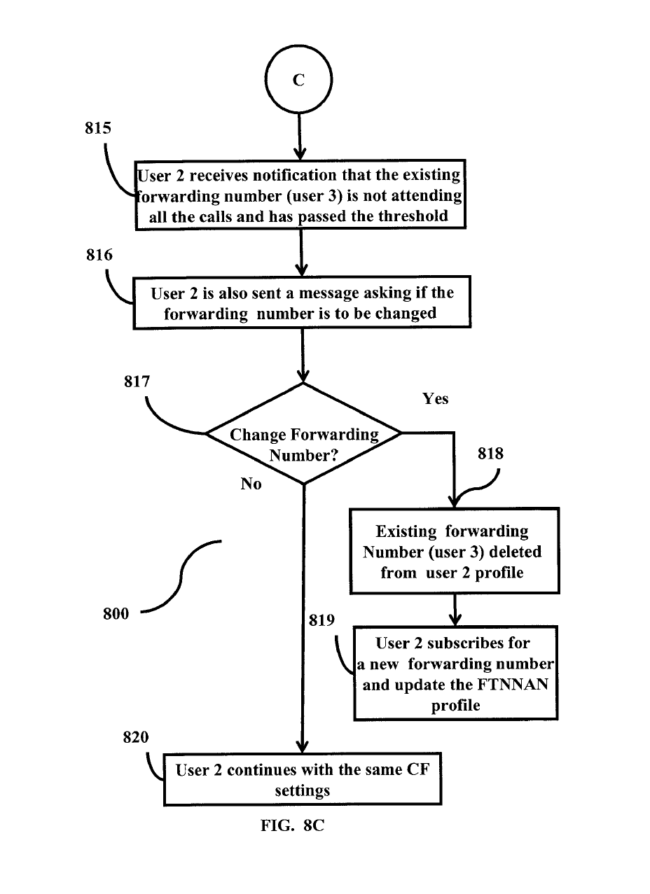

FIGS. 8A, 8B and 8C are flowcharts illustrating a method of evaluating and notifying the performance of a selected call forwarding number in an IP multimedia subsystem, according to the embodiments as disclosed herein. User 1 calls (801) user 2. User 1 initiates a call to served user 2 in using the below SIP commands:

INVITE sip:user 2@post.com
From: sip:user 1@post.com
To: sip:user 2@post.com

Application server (user 2) forwards (802) the call to user 3 based on the Call forwarding—CF profile. Application server (user 3) receives (803) the call forwarding invite. Application server (user 3) downloads (304) user 3 profile from the HSS and confirms (804) the CF notification indication is set for user 2. Next, the call forward no response—CFNR timer is started (805). The application server (user 3) checks (806), if the user 3 is free. If the user 3 is not free, then the application server (user 3) increments (811) the FTNNAN count in the call forwarding modification list (user 3). If user 3 is free a 180 ringing is sent (807) to the user 1 which initiates the call. IF the CFNR timer does not expire (808), the user 3 answers (809) the call from user 1 If the CFNR timer expires (808), user 3 terminates (810) the 180 call to user 1. The application server (user 3) terminating the call by sending CANCEL method to user 3 and BYE method to User 1. Application server (user 3) increments (811) FTNNAN count corresponding to user 2, in the call forwarding modification list (user 3). The application server then checks (812) if the FTNNAN count is greater than the threshold. If the count is greater than threshold, the threshold FTNNAN count is modified (814) in the HSS and the call forwarding modification list is sent (814) to user 2. If the count is not greater than threshold, the threshold FTNNAN count is modified (813) in the HSS. The threshold defines the number of calls a forward to number can miss. This threshold is currently decided by the network operator. In the notification below the threshold value is five, which means once the forward to number (user 3) has missed attending six calls, a notification is sent to user 2.

User 2 receives (815) a notification that the existing forwarding number (user 3) is not attending all the calls and has passed the threshold. The format of this notification may be as below:

NOTIFY SIP:User2@post.com
Event: FTNNAN
Datatype:application/xml
<data>
<FTNNAN count>5</FTNNAN Status?>
<Comment> Successful Subscription </Comment>
<Comment>
“No Answer/No of replies of user3@post.com reached threhold”
<comment>
<data>

User 2 is also sent a message asking (816) if the forwarding number is to be changed. If the user selects to change (817) the forwarding number, the existing forwarding number (user 3) is deleted (818) from user 2 profile and User 2 subscribes (819) for a new forwarding number and update the FTNNAN profile. If the user does not change (820) the call forwarding number, user 2 continues with same call forward settings. The various actions in method 800 may be performed in the order presented, in a different order or simultaneously. Further, in some embodiments, some actions listed in FIGS. 8A, 8B and 8C may be omitted.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for notifying a subscriber of calls not attended by a forward to identity in an internet protocol multimedia subsystem network, comprising of
forwarding by said network of a call to a forward to identity received by said subscriber, if said subscriber has call forwarding activated; and
informing said subscriber by said network, if said forward to identity not answering said call.

2. The method, as claimed in claim 1, wherein said method further comprises:
incrementing a counter by an application server, on said forward to entity not answering said call, wherein said counter counts number of calls missed by said forward to identity; and
comparing said counter to a threshold by said application server.

3. The method, as claimed in claim 2, wherein notifying said subscriber of calls not attended by said forwarded to number, if said counter value exceeds said threshold.

4. The method, as claimed in claim 2, wherein notifying said subscriber of calls not attended by said forwarded to number, if said counter value is equal to said threshold.

5. The method, as claimed in claim 2, wherein notifying said subscriber by said application server using a call session control function.

6. An internet protocol multimedia subsystem network comprising at least one means configured for
forwarding of a call to a forward to identity received by said subscriber, if said subscriber has call forwarding activated; and
informing said subscriber, if said forward to identity not answering said call.

7. The network, as claimed in claim 6, wherein said network further comprises of an application server, wherein said application server further comprises at least one means configured for
incrementing a counter, on said forward to entity not answering said call, wherein said counter counts number of calls missed by said forward to identity; and
comparing said counter to a threshold.

8. The network, as claimed in claim 7, wherein said application server is further configured for notifying said subscriber of calls not attended by said application server, if said counter value exceeds said threshold.

9. The network, as claimed in claim 7, wherein said application server is further configured for notifying said subscriber of calls not attended by said application server, if said counter value is equal to said threshold.

10. The network, as claimed in claim 7, wherein said application server further is further configured for notifying said subscriber using said call session control function.

11. An application server in an internet protocol multimedia subsystem network, said application server comprising at least one means configured for
forwarding of a call to a forward to identity received by said subscriber, if said subscriber has call forwarding activated; and
informing said subscriber, if said forward to identity not answering said call.

12. The application server, as claimed in claim 11, wherein said application server further comprises at least one means configured for
incrementing a counter, on said forward to entity not answering said call, wherein said counter counts number of calls missed by said forward to identity; and
comparing said counter to a threshold.

13. The application server, as claimed in claim 12, wherein said application server is further configured for notifying said subscriber of calls not attended by said forwarded to number, if said counter value exceeds said threshold.

14. The application server, as claimed in claim 12, wherein said application server is further configured for notifying said subscriber of calls not attended by said forwarded to number, if said counter value is equal to said threshold.

15. The application server, as claimed in claim 12, wherein said application server further is further configured for notifying said subscriber using said call session control function.
